(19) United States
(12) Patent Application Publication
(10) Pub. No.: US 2014/0169139 A1
(43) Pub. Date: Jun. 19, 2014

(54) HANDS-FREE TRUNK DOOR OPENING APPARATUS AND METHOD BASED ON THE SOUND

(71) Applicant: Hyundai Motor Company, Seoul (KR)

(72) Inventor: Seunghwan LEE, Hwasung-si (KR)

(73) Assignee: HYUNDAI MOTOR COMPANY, Seoul (KR)

(21) Appl. No.: 13/895,004

(22) Filed: May 15, 2013

(30) Foreign Application Priority Data
Dec. 13, 2012 (KR) 10-2012-0145320

(51) Int. Cl. G08C 23/02

(52) U.S. Cl. CPC G08C 23/02
USPC 367/197

(57) ABSTRACT

The present disclosure relates to a system and a method for automatically controlling opening/closing of a trunk door of a vehicle, and more particularly, to a technology for user with load in both hands to easily open the trunk door of a vehicle, by mounting a microphone at the rear of the vehicle such that the trunk door of the vehicle can be opened/closed in response to a sound inputted through the microphone.

### CROSS-REFERENCE TO RELATED APPLICATION

This application claims, under 35 U.S.C. §119(a), the benefit of priority to Korean Patent Application No. 10-2012-0145320 filed on Dec. 13, 2012, the entire contents of which are incorporated herein by reference.

### TECHNICAL FIELD

The present disclosure relates to a system and a method for automatically controlling opening/closing of a trunk door of a vehicle, and more particularly, to a technology for user with load in both hands to easily open the trunk door of a vehicle, by mounting a microphone at the rear of the vehicle such that the trunk door of the vehicle can be opened/closed in response to a sound inputted through the microphone.

### BACKGROUND ART

In general, the trunk door at the rear of a vehicle opens upward to easily load objects, which are difficult to be loaded inside the vehicle, into the trunk. The trunk door is opened by means of a device for opening/closing the trunk door around the driver's seat or by directly pulling the knob on the trunk door.

When using the trunk door with such a configuration, a user has to hold a large object with both hands during loading, so user's both hands are full with the objects. Therefore, the user cannot operate the knob on the trunk door and open the trunk in many cases.

Accordingly, a need exists for developing a way of being able to open the trunk door without using both hands.

In order to ease this discomfort, a technology about a hands-free trunk which opens a trunk door by recognizing movement of the users' legs behind a vehicle has been proposed and used.

The technology about a hands-free trunk door known in the art is implemented in the way of opening a trunk door by sensing movement of user's legs, that is, the motion of user's legs (kicks for the convenience) toward the rear of a vehicle.

However, according to this type of opening the trunk, a user has to move up his or her one leg to a predetermined height and/or within a predetermined time, with another leg supporting his or her body, to open the trunk door. Thus, the user has difficulty in moving his or her body with large or heavy load in the hands because the position is unstable and may get injured due to an accident such as falling down or hitting. Further, the user has to make a little large action to open the trunk door, so that it looks not good and may be unsatisfactory aesthetically.

Further, according to the technology of opening a trunk door via the movement of user's leg, a user has to kick his other leg in the air, but the movement does not provide a clear sensitive feedback in terms of body, so that it causes a psychological inconvenience.

Further, a system for the technology of opening a trunk door via the movement of user's leg is configured to recognize the movement of user's leg, with two infrared sensors equipped on the top and the bottom of the bumper of a vehicle. However, the percentage of successful recognition may be considerably low due to the positions of the two sensors and the radius of the movement due to the difference in height and length of legs of various users.

### SUMMARY OF THE DISCLOSURE

The present disclosure has been made in an effort to solve the problems and an object of the present disclosure is to allow users with load in both hands to easily open the trunk door of a vehicle by mounting a microphone at the rear of the vehicle such that the trunk door of the vehicle can be opened/closed in response to a sound inputted through the microphone, in order to automatically control opening/closing of the trunk door at the rear of a vehicle.

In order to achieve the object of the present disclosure, an apparatus for opening/closing a hands-free trunk door of a vehicle, based on a sound, which uses a smart key. The apparatus includes: a microphone that is disposed at the rear of a vehicle and generates and outputs a sound signal, when a sound is inputted; a controller that generates and outputs a control signal, when receiving the sound signal from the microphone; and an actuator that is connected with a lock of the trunk door of a vehicle and opens the lock of the trunk door in response to the control signal received from the controller.

The apparatus further includes a smart key controller that generates and outputs a smart key signal by recognizing a smart key, in which the controller generates and outputs the control signal, only when the smart key signal is inputted from the smart key controller.

The controller generates and outputs a control signal, only when the received sound signals correspond to single sounds and sound signals with the same frequency are inputted within a predetermined interval.

The controller generates and outputs a control signal, only when the received sound signals are sounds with a magnitude larger than a predetermined magnitude.

The microphone includes a directional microphone.

A method of opening/closing a trunk door of a vehicle includes: determining whether a smart key signal is inputted from a smart key controller with a sensor controller in a standby status; standing by an input of a microphone signal from a microphone by means of the sensor controller; determining whether the microphone signal corresponds to a single sound by means of the sensor controller; determining whether another sound with the same frequency is inputted within a predetermined time through the microphone by means of the sensor controller; operating an actuator that operates with a lock of the trunk door, when the microphone signal corresponds to a single sound and another sound with the same frequency is inputted within a predetermined time, by means of the sensor controller; and cutting power applied to the microphone and/or the sensor controller by means of the sensor controller.

### BRIEF DESCRIPTION OF THE DRAWINGS

The above and other features of the present disclosure will now be described in detail with reference to certain exemplary embodiments thereof illustrated the accompanying drawings which are given herein below by way of illustration only, and thus are not limitative of the present disclosure, and wherein: FIG. 1 is a view showing the configuration of a system according to an exemplary embodiment of an apparatus for opening/closing a hands-free trunk door based on a sound and a method thereof;

FIG. 2 is a view showing actual examples of components in the system according to an exemplary embodiment of an apparatus for opening/closing a hands-free trunk door based on a sound and a method thereof;

FIG. 3 is a conceptual view showing a structure of arranging a microphone and receiving an input sound; and

FIG. 4 is a flowchart illustrating a method of opening a hands-free trunk based on a sound according to an exemplary embodiment of the present disclosure.

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, exemplary embodiments of the present disclosure will be described in detail with reference to the accompanying drawings.

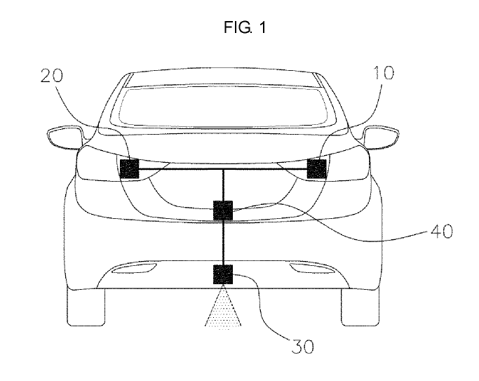

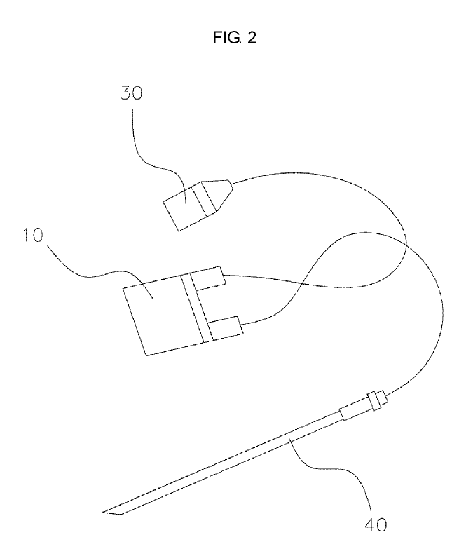

FIG. 1 is a view showing the configuration of a system according to an exemplary embodiment of an apparatus for opening/closing a hands-free trunk door based on a sound and a method thereof, and FIG. 2 is a view showing actual examples of components in the system according to an exemplary embodiment of an apparatus for opening/closing a hands-free trunk door based on a sound and a method thereof.

The system includes a microphone 30 and allows a user to easily open a trunk door without using a hand, by making the trunk door be opened by recognizing a sound inputted through the microphone 30.

To this end, the apparatus for opening/closing a hands-free trunk door based on a sound and a method thereof include, as shown in FIG. 1, a smart key controller 20, a sensor controller 10, an actuator 40, and a microphone 30.

The smart key controller 20 controls an input by a smart key cooperating with a driving system of a vehicle and a trunk door of a vehicle is opened only when there is an input by a smart key in cooperation with the smart key controller 20. The smart key controller 20 allows the sensor controller 10 to recognize that there has been an input by a smart key, by outputting and transmitting a smart key signal to the sensor controller 10, which is described below, when there is an input by a smart key.

The configuration prevents incorrect operations of the trunk door and the trunk door from being unexpectedly opened by other people except for a user or by other sounds.

The sensor controller 10 analyzes the frequency of a microphone signal inputted from the microphone 30, generates a control signal by determining the frequency, and activates the actuator 40, in cooperation with the smart key controller 20 and the microphone 30 that is described below. The sensor controller 10, as described above, activates the actuator 40 only when there has been an input of a smart key signal, after determining whether there is an input of a smart key signal in cooperation with the smart key controller 20.

According to an exemplary embodiment of the present disclosure, a user is guided to knock the ground with a foot (making a sound by hitting the ground with the sole of a foot) in order to open the trunk door of a vehicle equipped with the apparatus for opening/closing a hands-free trunk door based on a sound. The user is guided to knock twice in succession the ground around the trunk door at the rear of a vehicle in order to prevent an incorrect operation and the trunk door of the vehicle is opened in response to the continuous single sounds.

To this end, the sensor controller 10 receives a microphone signal inputted from the microphone 30 that is described below, and generates and outputs a control signal only when sounds with the same frequency and magnitude are inputted with a predetermined interval, for example within 1 second or 1.5 seconds, and the control signal is transmitted to the actuator 40 such that the actuator 40 actuates the trunk door.

Further, it is preferable that the sensor controller 10 opens the trunk door, only when a sound with a magnitude larger than a predetermined magnitude is inputted.

This configuration opens the trunk door, only when a user knocks the ground, close to the vehicle while preventing the trunk door from being opened by other sounds from other people at a predetermined distance or more from the vehicle, except for the user.

Therefore, it is preferable that the sensor controller 10 controls the trunk door to automatically open by activating the actuator 40, only when sound signals with the same frequency are inputted within a predetermined interval from the microphone 30 that is described below, that is, when sounds with a magnitude larger than a predetermined magnitude are equally received, which makes it possible to prevent the trunk door from unexpectedly opening.

The microphone 30, a device known in the art which converts an input sound into an electric signal and outputs the converted electric signal, is provided to open the trunk door by receiving an sound from the user behind a vehicle.

When a sound is inputted, the microphone 30 cooperating with the sensor controller 10 converts the sound into a microphone signal and transmits the converted signal to the sensor controller 10, so that the sounds generated by the user who knocks the ground with a foot is inputted to the sensor controller 10.

The microphone 30 is preferably disposed at the rear of a vehicle, and more preferably in the bumper at the lower portion of the rear of a vehicle to be able to receive a sound from a user behind the vehicle without deteriorating the external appearance of the vehicle.

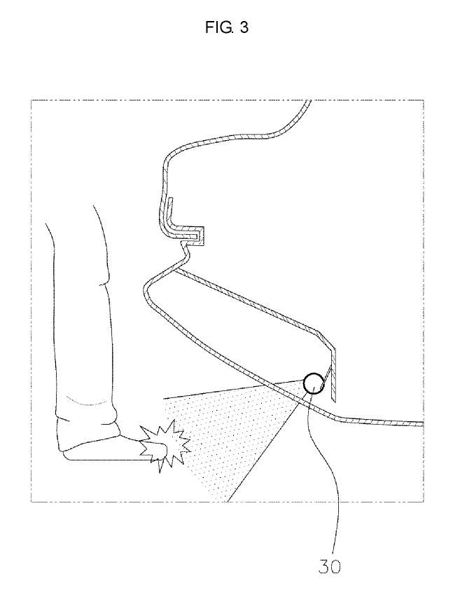

FIG. 3 shows a conceptual example of the arrangement of the microphone 30 and the structure for receiving a sound.

According to an exemplary embodiment of the present disclosure, the microphone 30 may include a directional microphone 30 known in the art. The directional microphone 30 is a microphone 30 set to receive only sounds that are inputted within a predetermined range in a set direction, so that it is possible to more accurately receive sounds from a user behind a vehicle and to prevent other sounds, except for the sounds from the user, from being inputted.

The actuator 40 is connected with the trunk door of a vehicle and opens the trunk door when a control signal is received from the sensor controller 10.

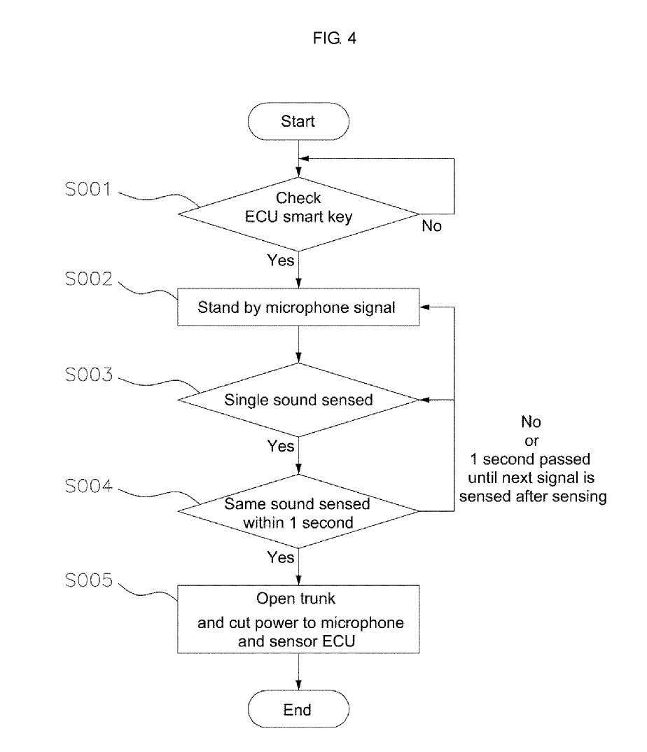

FIG. 4 is a flowchart illustrating a method of opening a hands-free trunk based on a sound with the configuration according to an exemplary embodiment of the present invention.

The method of opening a hands-free trunk based on a sound of the present disclosure is implemented by controlling the actuator 40 with the sensor controller 10 described above, in which the method opens a trunk door in response to signals inputted from the smart key controller 20 and the microphone 30.

First, the sensor controller 10 determines whether a smart key signal is inputted from the smart key controller 20 in a standby status (S001). The determining of whether a smart key signal is inputted from the smart key controller 20 purports to prevent an incorrect operation of a trunk door, as described above, that is, to prevent the trunk door from unexpectedly opened by people except for the user or other sounds.

The sensor controller 10 stands by an input of a microphone signal from the microphone 30, when a smart key signal is inputted from the smart key controller 20 (S002). That is, the sensor controller 10 does not stand by an input of a microphone signal, when a smart key signal is not inputted from the smart key controller 20, which provides an advantage of being able to prevent an unwanted opening of the trunk door and unnecessary waste of power.

The sensor controller 10 determines whether a single sound is inputted through the microphone 30 (S003). The single sound is the sound made by a user who knocks the ground, and the sensor controller 10 determines whether a single sound is inputted, and stands by a microphone signal, when a single sound is not inputted.

In step S003, when a single sound is inputted from the microphone 30, the sensor controller 10 determines whether another sound with the same frequency is inputted within a predetermined time, for example, within 1 second (S004).

This configuration allows a trunk door of a vehicle to open, only when sounds with the same frequency are sequentially inputted by a user who knocks the ground around the trunk door of a vehicle, twice in the same way, in order to prevent the trunk door from unexpectedly opening. Therefore, the sensor controller 10 receives a microphone signal inputted through the microphone 30 that is described below and generates and outputs a control signal for operating the actuator 40, when sounds with the same frequency and magnitude are inputted within a predetermined interval.

If it is determined that sounds with the same frequency are not continuously inputted to the sensor controller 10 within a predetermined time, the sensor controller 10 stands by a microphone signal again.

In step S004, when sequentially receiving sound signals with the same frequency within a predetermined time, the sensor controller 10 makes the trunk door be opened by generating and transmitting a control signal for operating the actuator 40 operating with a lock (not shown) of the trunk door in order to open the trunk door (S005).

Further, since the trunk door is open, it is possible to cut the power supplied to the microphone 30 and/or the sensor controller 10 which does not need power any longer.

The present disclosure having the configuration provides the following advantages.

### 1) Enhanced Convenience

According to the apparatus for opening/closing a hands-free trunk door based on a sound and a method thereof of the present disclosure, a user with loads to put in a trunk of a vehicle in his/her hands can open a trunk door without using a hand by making sounds with a foot knocking the ground, so that convenience for the user is improved.

Further, since a user does not need to put down the objects in his/her hands to open the trunk door, as compared with the trunk doors used in the related art which makes user put down objects in his/her hand on the ground and then open it up to open s trunk, it is possible to preclude musculoskeletal system disorder of the users due to excessive bending-over.

### 2) Increased User's Satisfaction

In general, the locks and knobs of the trunk doors at the rear of vehicles may be easily stained by external pollutants, but according to the present disclosure it is possible to open a trunk door without touching the knob of the trunk door, so that satisfaction of a user can be improved.

Further, as compared with the technology of the related art which makes a user's body unbalanced by kicking with heavy loads in his/her hand to open a trunk door, a user can open a trunk door by moving his/her foot with the central axis of the body stably supported, such that inconvenience and instability of the user can be removed.

Although exemplary embodiments of an apparatus for opening/closing a hands-free trunk door and a method thereof of the present disclosure, those are only specific examples for helping understanding of the present disclosure, not limiting the scope of the present disclosure. It is apparent to those skilled in the art that the present disclosure may be modified in various ways on the basis of the spirit of the present inventive concept other than the embodiments described herein.

What is claimed is:

1. An apparatus for opening/closing a hands-free trunk door based on a sound which uses a smart key, the apparatus comprising:
a microphone that is disposed at the rear of a vehicle and generates and outputs a sound signal, when a sound is inputted;
a controller that generates and outputs a control signal, when receiving the sound signal from the microphone; and
an actuator that is connected with a lock of the trunk door of a vehicle and opens the lock of the trunk door in response to the control signal received from the controller.

2. The apparatus of claim 1, further comprising a smart key controller that generates and outputs a smart key signal by recognizing a smart key,
wherein the controller generates and outputs the control signal, only when the smart key signal is inputted from the smart key controller.

3. The apparatus of claim 1, wherein the controller generates and outputs the control signal, only when the received sound signals correspond to single sounds and sound signals with the same frequency are inputted within a predetermined interval.

4. The apparatus of claim 1, wherein the controller generates and outputs the control signal, only when the received sound signals are sounds with a magnitude larger than a predetermined magnitude.

5. The apparatus of claim 1, wherein the microphone includes a directional microphone.

6. A method of opening/closing a hands-free trunk door based on a sound, the trunk door including the apparatus for opening/closing a trunk door of any one of claim 1, the method comprising:
determining whether a smart key signal is inputted from a smart key controller with a sensor controller in a standby status;
standing by an input of a microphone signal from a microphone by means of the sensor controller;
determining whether the microphone signal corresponds to a single sound by means of the sensor controller;
determining whether another sound with the same frequency is inputted within a predetermined time through the microphone by means of the sensor controller;
operating an actuator that operates with a lock of the trunk door, when the microphone signal corresponds to a single sound and another sound with the same frequency is inputted within a predetermined time, by means of the sensor controller; and
cutting power applied to the microphone and/or the sensor controller by means of the sensor controller.
